(19) United States
(12) Patent Application Publication
(10) Pub. No.: US 2018/0189378 A1
(43) Pub. Date: Jul. 5, 2018

(54) PERSONALIZED SOCIAL MEDIA ACTIONS BASED ON EMINENCE TRAITS

(71) Applicant: International Business Machines Corporation, Armonk, NY (US)

(72) Inventors: Maya Barnea, Kiriat Bialik (IL); Avraham A. Kaplan, Carmiel (IL); Shiri Kremer, Yavniel (IL); Lior Leiba, Haifa (IL); Inbal Ronen, Haifa (IL)

(21) Appl. No.: 15/855,513

(22) Filed: Dec. 27, 2017

Related U.S. Application Data
(63) Continuation of application No. 15/398,035, filed on Jan. 4, 2017.

(51) Int. Cl. G06F 17/30; H04L 29/08; G06F 17/24; G06Q 50/00

(52) U.S. Cl. CPC G06F 17/30601; H04L 67/2833; H04L 67/22; G06Q 50/01; G06F 17/30554; G06F 17/3053; G06F 17/248

(57) ABSTRACT

An approach for creating personalized recommended social media actions to improve social eminence within a social network. A social action engine receives persona social traits, social graphs associated with a user. The social action engine receives predetermined recommendation templates for grouping recommended social actions. The social action engine creates a matching matrix based on matching action categories of the recommendation templates with the persona social traits for the user. The social action engine scores matching matrix cells of the matching matrix with a pattern score based on the persona social traits. The social action engine analyzes the social graphs to create the recommended social actions and outputs the recommended social actions where the recommended social actions are grouped by the recommendation templates respectively.

### STATEMENT REGARDING PRIOR DISCLOSURES

The following disclosure(s) are submitted under 35 U.S.C. 102(b)(1)(A):

(i) Portions of the disclosure presented by International Business Machines Corporations at Connect 2016, “The Premier Social Business and Digital Experience Conference”, Jan. 31-Feb. 3, 2016, http://ibm-connect-2016.mybluemix.net/NewWayToWork/.

### BACKGROUND OF THE INVENTION

The present invention relates generally to enterprise social software and more specifically, to recommended social actions for use in enterprise social network software systems.

Advances in communication technology has led to an increasing number of organizations acknowledging the benefits of enterprise social software and implementing enterprise social software for employee collaboration which can enable knowledge sharing between individuals and teams and increase an organization's workforce engagement. When used effectively, enterprise social network software systems can help individual employees/users to become more socially eminent while increasing collaboration and knowledge sharing. However, many users do not know how to effectively use enterprise social software and/or are unsuccessful in gaining the benefits of social networking by neglecting the potential value of enterprise social software.

One aspect lacking in enterprise social network software systems is that users often do not receive feedback on the effectiveness of their social activity or any metrics in regards to their social standing (e.g., eminence in their enterprise social community). In another shortcoming of the use of enterprise social systems, users can be deficient in knowing what action can/should be taken to establish their social presence within the enterprise social network software system to improve their social community standing.

### SUMMARY

As disclosed herein, a method for creating personalized recommended social media actions to improve social eminence within a social network, the method comprising: receiving by, a social action engine, persona social traits and one or more social graphs associated with a user; receiving by, the social action engine, predetermined one or more recommendation templates for grouping one or more recommended social actions; creating, by the social action engine, a matching matrix based on matching action categories of the one or more recommendation templates with the persona social traits for the user; scoring, by the social action engine, matching matrix cells of the matching matrix with a pattern score based on the persona social traits; analyzing, by the social action engine, the one or more social graphs to create the one or more recommended social actions and outputting, by the social action engine, the one or more recommended social actions wherein the one or more recommended social actions are grouped by the one or more recommendation templates respectively. A computer system and a computer program product corresponding to the above method are also disclosed herein.

### BRIEF DESCRIPTION OF THE DRAWINGS

The present invention is described in the detailed description, which follows, references the noted plurality of drawings by way of non-limiting examples of exemplary embodiments of the present invention.

FIG. 1 illustrates a functional block diagram of a computing environment, in accordance with an embodiment of the present invention;

FIG. 2 illustrates a flowchart of operational steps of a social action technique for improving social eminence in a social networking environment, in accordance with an embodiment of the present invention;

FIG. 3 illustrates sample output of recommended social actions, in accordance with an embodiment of the present invention; and

FIG. 4 illustrates a block diagram of components of the server and/or the computing device, in accordance with an embodiment of the present invention.

### DETAILED DESCRIPTION

Embodiments of the present invention provide an approach to identifying personalized user feedback on social engagement and creating recommended actions to increase social eminence within a social network.

Social eminence can be described as a measure of person's leadership and/or influence among others in a social network and the embodiments depicted and described herein recognize the need for improving social eminence in an enterprise social networking arena based on recommending targeted social actions. Enterprise social networking can be described as an online social network shared among users with common business interests and/or activities. Social networks can encompass collaborative tools such as, but not limited to, blog, forum, wiki and community (page). It should be noted that some embodiments are described in context of enterprise social networking and wherein enterprise social networking be incorporated in public social networking environments, some embodiments can be considered for use in general social networking software environments.

Embodiments of the present invention can generate personalized recommend social actions based on analyzing a user's social network behavior and social network engagement patterns (e.g., persona social traits) while using enterprise social network software. Personalized recommended social actions can be specific to a user and include supporting justification (e.g., explanation/rationale of why a social action was recommended). For example, some embodiments described herein provide the capability to improve a user's social eminence by recommending social actions that can affect factors such as, but not limited to, configuring a social environment (e.g., extending a social network), selecting optimal people to follow, becoming more influential (e.g., shifting from reacting to social content to creating social content), effectively promoting social content, effectively socializing (e.g., attracting others to presented social content) and engaging with those engaging with the presented social content. Based on a user taking actions to complete recommend social actions, embodiments described herein, can improve the user's social eminence within the organization. Improving a user's social eminence can increase the value of the enterprise social network software for an organization, increase a user's intellectual value to an organization and project a user's influence in their areas of interest/expertise. Recommended actions can comprise action such as, but not limited to, connect, follow, like, comment, tag, create, share, join, follow and post. Some embodiments can determine recommended social actions based on searching and analyzing a user's social activities (e.g., comprising factors such as, but not limited to, user activities, other user activities in the user's network and other activities affecting social content items associate with the user) by incorporating the user's persona social traits and social network software analytics. It should be noted in some embodiments described herein can be incorporated into social network software such as, but not limited to Personal Social Dashboard by International Business Machines Corporation.

Embodiments of the present invention will now be described in detail with reference to the figures. It should be noted that references in the specification to “an exemplary embodiment,” “other embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure or characteristic is described in connection with an embodiment, it is submitted that it is within the knowledge of one skilled in the art to affect such feature, structure or characteristic in connection with other embodiments whether or not explicitly described.

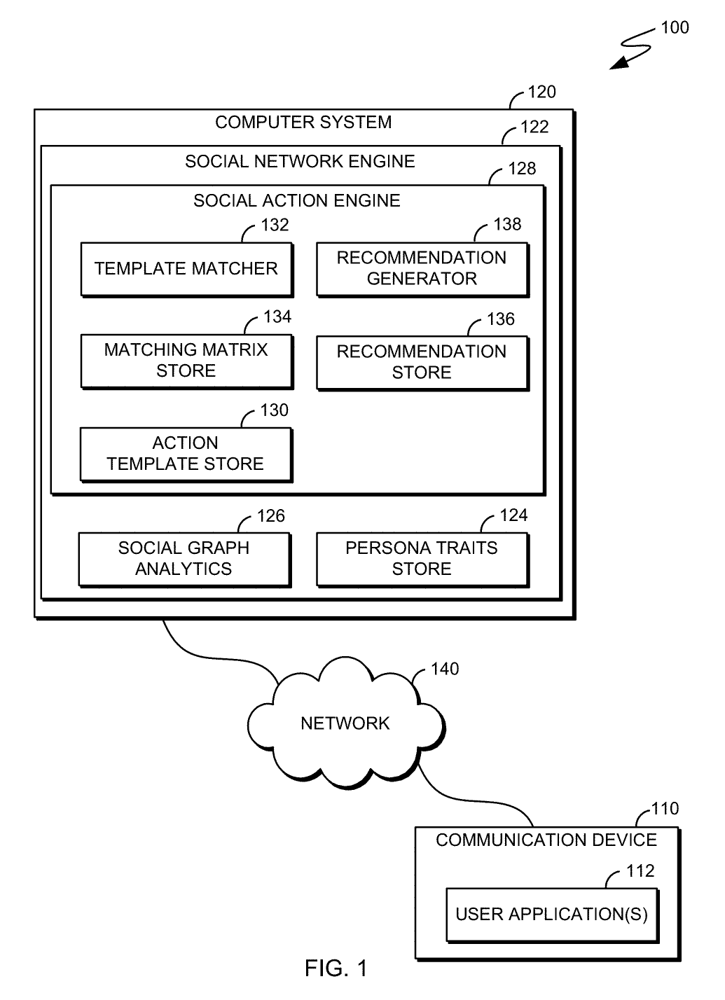

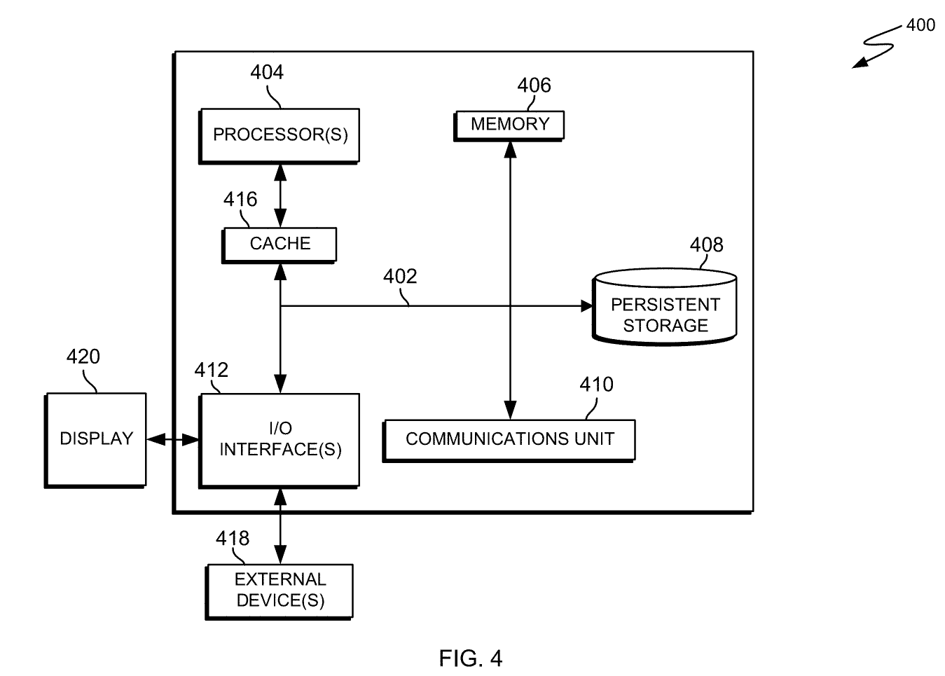

FIG. 1 illustrates a functional block diagram of computing environment 100, in accordance with an embodiment of the present invention. Computing environment 100 comprises COMMUNICATION DEVICE 110 and COMPUTER SYSTEM 120, interconnected via NETWORK 140. COMMUNICATION DEVICE 110 and COMPUTER SYSTEM 120 can be desktop computers, laptop computers, specialized computer servers, or the like. In certain embodiments, COMMUNICATION DEVICE 110 and COMPUTER SYSTEM 120 collectively represent computer systems utilizing clustered computers and components acting as a single pool of seamless resources via NETWORK 140. For example, such embodiments can be used in data center, cloud computing, storage area network (SAN), and network attached storage (NAS) applications. In general, COMMUNICATION DEVICE 110 and COMPUTER SYSTEM 120 are representative of any electronic devices, or combination of electronic devices, capable of executing computer readable program instructions, as described in detail with regard to FIG. 4.

In some embodiments, COMMUNICATION DEVICE 110 can be a plurality of COMMUNICATION DEVICES 110 and COMMUNICATION DEVICE 110 can be a separate and/or integrated tool that can operate with social networking software/applications. In the depicted embodiment, COMMUNICATION DEVICE 110 comprises USER APPLICATION(S) 112 where USER APPLICATION(S) 112 can be a plurality of USER APPLICATION(S) 112 within COMMUNICATION DEVICE 110. USER APPLICATION(S) 112 can access/operate social networking applications and in some embodiments USER APPLICATION(S) 112 can operate a related social action engine. In some embodiments, USER APPLICATION(S) 112 can comprise any combination of commercial or custom devices and/or software products associated with social networking engagement.

NETWORK 140 can be, for example, a local area network (LAN), a wide area network (WAN) such as the Internet, or a combination of the two, and include wired, wireless, or fiber optic connections. In general, NETWORK 140 can be any combination of connections and protocols that can support communications between COMMUNICATION DEVICE 110 and COMPUTER SYSTEM 120, in accordance with some embodiments.

In some embodiments, COMPUTER SYSTEM 120 comprises, SOCIAL NETWORK ENGINE 122. In some embodiments, SOCIAL NETWORK ENGINE 122 can be a plurality of SOCIAL NETWORK ENGINES 122 within COMPUTER SYSTEM 120. SOCIAL NETWORK ENGINE 122 can operate social networking collaboration tools such as, but not limited to, blogs, file management, forums and wikis. Further, SOCIAL NETWORK ENGINE 122 can manage a network of informational objects and users while tracking a variety of relationship/activities between the users and the informational objects. In some embodiments, SOCIAL NETWORK ENGINE 122 can comprise any combination of commercial or custom devices and/or software products associated with operating social networks and/or enterprise social networks. In some embodiments, SOCIAL NETWORK ENGINE 122 comprises, PERSONA TRAITS STORE 124, SOCIAL GRAPH ANALYTICS 126 and SOCIAL ACTION ENGINE 128.

In some embodiments, PERSONA TRAITS STORE 124 can be a plurality of PERSONA TRAITS STORES 124 within SOCIAL NETWORK ENGINE 122. PERSONA TRAITS STORE 124 can store information such as, but not limited to, user settings and predetermined persona social traits based on the user's social behavior/traits can comprise information such as, but not limited to, volume of social content postings, a count of people following the user, the number of people the user follows, etc. PERSONA TRAITS STORE 124 can operate with TEMPLATE MATCHER 132 and SOCIAL GRAPH ANALYTICS 126.

In some embodiments, SOCIAL GRAPH ANALYTICS 126 can be a plurality of SOCIAL GRAPH ANALYTICS 126 within SOCIAL NETWORK ENGINE 122. SOCIAL GRAPH ANALYTICS 126 can perform analytics based on information comprising one or more social graphs to identify insights (e.g., deep understanding of social patterns) within the context of an activities and relationships in a social network. Social graph can represent a context of relationships and social interactions (e.g., direct and indirect) associated with digital artifacts (e.g., users, information, etc.). Further, as social graphs can codify relationships among users, the social graph can identify individual-object interaction patterns in context of time and frequency. For example, interaction pattern factors such as, but not limited to, comment/content brevity, elapsed time for a user to create a posting, user response time to postings/questions and age of user social activities can contribute to analytic measures comprising SOCIAL GRAPH ANALYTICS 126. It should be noted that SOCIAL GRAPH ANALYTICS 126 can analyze social network data and/or social network metadata (e.g., data about data) to formulate social engagement measures and can act as an information source for SOCIAL ACTION ENGINE 128. Social network data can be described as social activities that a user performs over time whereas social network metadata can be described as information related toward a user's skills/experience (e.g., user job role, years with a company and organizational role, etc.).

In some embodiments, SOCIAL ACTION ENGINE 128 can be a plurality of SOCIAL ACTION ENGINES 128 within SOCIAL NETWORK ENGINE 122. SOCIAL ACTION ENGINE 128 can operate with SOCIAL NETWORK ENGINE 122 to analyze social activities/presence to create and output personalized recommended social actions that can be taken by a user to increase their social eminence. In some embodiments, SOCIAL ACTION ENGINE 128 can operate in conjunction with a combination of commercial or custom devices and/or software products associated with creating and managing personalized recommended social actions. In some embodiments, SOCIAL ACTION ENGINE 128 comprises, ACTION TEMPLATE STORE 130, TEMPLATE MATCHER 132, MATCHING MATRIX STORE 134, RECOMMENDATION STORE 136 and RECOMMENDATION GENERATOR 138.

In some embodiments, ACTION TEMPLATE STORE 130 can be a plurality of ACTION TEMPLATE STORES 130 within SOCIAL ACTION ENGINE 128. ACTION TEMPLATE STORE 130 can be a data store for predetermined recommendation templates available for processing by TEMPLATE MATCHER 132 and RECOMMENDATION GENERATOR 138. Recommendation template can be characterized as a grouping of information related toward types of actions that a user could be recommended to perform to increase social eminence. For example, social eminence can be affected by factors such as, but not limited to, a user's social networking activity (e.g., collaborative activities and type of involvement), social reaction (e.g., type of feedback and response received) and network (e.g., network size and diversity of networked user skills/interests). Recommendation templates (e.g., ACTION TEMPLATE STORE 130) related to factors affecting social eminence can comprise template action types/topics such as, but not limited to, follow a person, connect with a person, create a posting and share a file. Example recommendation templates can use terms such as, but not limited to, ‘Follow more people’, ‘Extend your Network’, ‘Lead conversations’ and ‘Sustain your conversations’. The recommendation templates can be associated with action categories to enable grouping of recommended social actions within a recommendation template and recommendation templates can act as logical containers to group recommended social actions for output toward a user to for display and receiving user interaction input.

In some embodiments, TEMPLATE MATCHER 132 can be a plurality of TEMPLATE MATCHERS 132 within SOCIAL ACTION ENGINE 128. TEMPLATE MATCHER 132 can analyze persona social traits, received from PERSONA TRAITS STORE 124 for a user and compare recommendation templates received from ACTION TEMPLATE STORE 130 to identify and match recommendation template(s) based on a user's persona social traits. It should be noted that the persona social traits can be analyzed to determine social weaknesses the user may exhibit and based on TEMPLATE MATCHER 132 analysis, a matching matrix for a user can be creating and pattern scored for relevancy toward associated recommendation templates. For example, some embodiments can create a matching matrix of juxtaposing users versus recommendation templates. For example, a matching matrix column can identify a specific user (e.g., Mary Smith); a row can identify a specific recommendation template (e.g., ‘Lead conversation’) and the value of a matching matrix cell can contain a pattern score (e.g., a value between 0 to 1). The pattern score can represent the relevancy and/or matching level of the recommendation template related toward a user and can be based on domain knowledge encapsulated in rules based algorithms. It should be noted that matching matrix content and pattern scores can be updated as PERSONA TRAITS STORE 124 content changes. Matching matrix information from TEMPLATE MATCHER 132 can be sent toward

MATCHING MATRIX STORE 134 for storage and use by RECOMMENDATION GENERATOR 138.

In some embodiments, MATCHING MATRIX STORE 134 can be a plurality of MATCHING MATRIX STORES 134 within SOCIAL ACTION ENGINE 128. MATCHING MATRIX STORE 134 can be a data store a history of user based matching matrices based on TEMPLATE MATCHER 132 processing. It should be noted that MATCHING MATRIX STORE 134 can store social network data and/or social network metadata associated with user matching matrices that can be used for selecting, prioritizing and/or grouping the output of recommended social actions.

In some embodiments, RECOMMENDATION STORE 136 can be a plurality of RECOMMENDATION STORES 136 within SOCIAL ACTION ENGINE 128. RECOMMENDATION STORE 136 can store recommended social actions determined by RECOMMENDATION GENERATOR 138. RECOMMENDATION STORE 136 can be an information source for RECOMMENDATION GENERATOR 138 to receive a history of recommended social actions and social action status. Social action status can be described as indicators to that identify actions have been taken by a user toward the user's respective recommended social actions. For example, a personal recommendation template to follow can contain a recommended social action that is configured for Mary Smith could state “Follow John Doe because you have recently interacted with John Doe or his content.” If Mary Smith takes action to follow John Doe, then the action can change the social action status so that the recommended follow action for John Doe can cease to be a recommended social action.

In some embodiments, RECOMMENDATION GENERATOR 138 can be a plurality of RECOMMENDATION GENERATORS 138 within SOCIAL ACTION ENGINE 128. RECOMMENDATION GENERATOR 138 can receive information from MATCHING MATRIX STORE 134, RECOMMENDATION STORE 136 and SOCIAL GRAPH ANALYTICS 126 to create/update recommended social actions for output toward a user. RECOMMENDATION GENERATOR 138 can receive a user's current matching matrix (e.g., MATCHING MATRIX STORE 134) and based on SOCIAL GRAPH ANALYTICS 126, can determine groupings of specific/personalized social actions associated with respective recommendation templates and can determine associated social action rationale for a respective social action to create recommended social actions. RECOMMENDATION GENERATOR 138 can receive information/social graph from SOCIAL GRAPH ANALYTICS 126 and RECOMMENDATION GENERATOR 138 can traverse the social graph to identify social actions to recommend social actions along with social network activity evidence to support social action rationale comprising a recommended social action. For example, if recommended social action is identified to follow a person, then RECOMMENDATION GENERATOR 138 can find a user node, in a social graph, to identify other person nodes linked with the user to recommend connecting with another user (e.g., represented by another person node). It should be noted that social graph node information such as, but not limited to, quantity of paths and type of paths between users in the social graph can increase/decrease the strength of the social action rationale for a recommended social action. It should be further noted that example recommended social actions can use terms such as, but not limited to, ‘follow person X’, ‘add person X to your network’, ‘create a status update in community X’, ‘write a blog entry in blog X’, ‘reply to comments placed on your status update X’ and ‘write a blog entry on file X that gained a lot of interest’ It should be noted that in some embodiments, a new social user may have an insubstantial social graph and the new social user can receive predetermined recommended social actions to guide the new social user with first steps towards increasing social eminence whereas novice/advanced social users can be presented with more specific recommended social actions (e.g., social actions and social action rationale) as a respective social networking activity corpus (e.g., body of knowledge) of novice/advanced social users develop (e.g., SOCIAL GRAPH ANALYTICS 126). In some embodiments, a user can launch a display of recommended social actions where RECOMMENDATION GENERATOR 138 can determine and output the current recommended social actions in response to the user interaction input. As a user interacts with a recommended social action in the collection of recommended social actions, the social action status of the social action can be recorded as the recommended social action is acted upon. For example, Mary Smith could perform an action to follow John Doe and the action taken can cause a suppression and/or deactivation of further output by RECOMMENDATION GENERATOR 138 based on the social action status change caused by Mary Smith's social interaction. Further, RECOMMENDATION GENERATOR 138 can send social action status updates associated with respective recommended social actions toward RECOMMENDATION STORE 136.

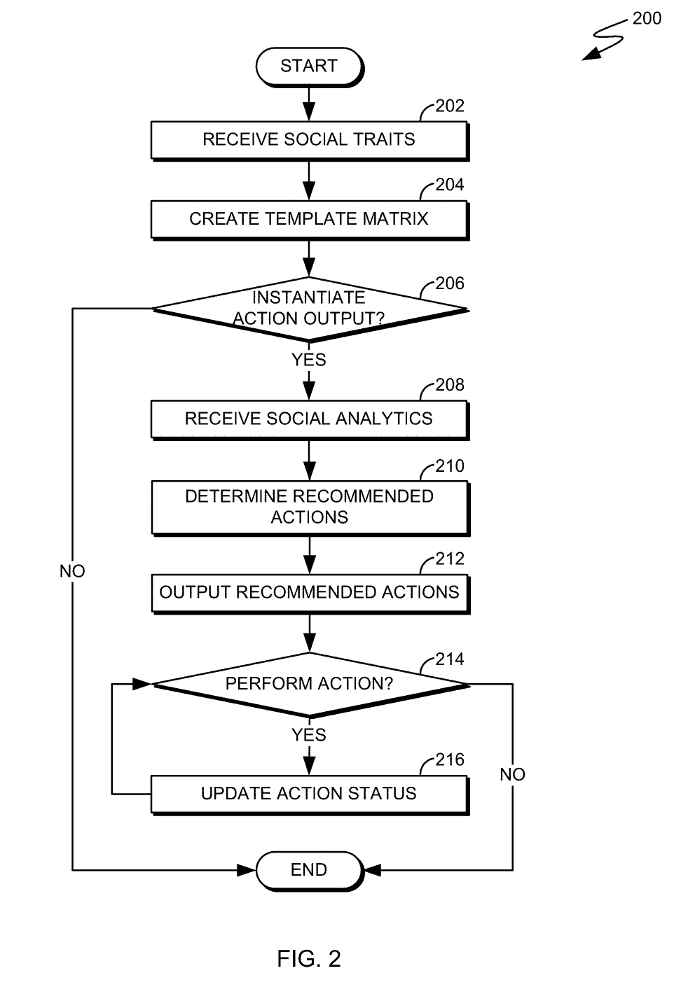

FIG. 2 illustrates a flowchart of operational steps of a social action technique for improving social eminence in a social networking environment, in accordance with an embodiment of the present invention. Social action engine flow 200, comprises operations RECEIVE SOCIAL TRAITS 202, CREATE TEMPLATE MATRIX 204, INSTANTIATE ACTION OUTPUT 206, RECEIVE SOCIAL ANALYTICS 208, DETERMINE RECOMMENDED ACTIONS 210, OUTPUT RECOMMENDED ACTIONS 212, PERFORM ACTION 214 and UPDATE ACTION STATUS 216.

Operation RECEIVE SOCIAL TRAITS 202, can receive persona social traits (e.g., PERSONA TRAITS STORE 124) and recommendation templates (e.g., ACTION TEMPLATE STORE 130) for processing by TEMPLATE MATCHER 132. It should be noted that operation RECEIVE SOCIAL TRAITS 202 can receive persona social traits and recommendation templates for processing based on methods such as, but not limited to, periodic data feeds and initiated by user activation of SOCIAL ACTION ENGINE 128 via a user interface (e.g., SOCIAL NETWORK ENGINE 122). When operation RECEIVE SOCIAL TRAITS 202 completes, processing proceeds toward operation CREATE TEMPLATE MATRIX 204.

In operation CREATE TEMPLATE MATRIX 204, TEMPLATE MATCHER 132 can match user recommendation templates (e.g., ACTION TEMPLATE STORE 130) with persona social traits (e.g., PERSONA TRAITS STORE 124) to create/update the user's matching matrix and the matching matrix cells (e.g., intersections within the matching matrix) can be scored based on eminence relevancy. The relevancy score (e.g., pattern score) can be determined by a rule-based algorithm that compares persona social traits with recommendation templates identified in a user's matching matrix. The output of the pattern scoring algorithm can range from 0 to 1 to identify the relevancy of a recommendation template for a user. For example, a pattern score of ‘0’, ‘0.7’ and ‘1’ can indicate a recommendation template has respectively, no relevancy, partially strong relevancy and strong relevancy. It should be noted that recommendation templates and associated recommended social actions can selected for presentation/output based on pattern scoring values comprising a user's matching matrix. It should be further noted that an output quantity and/or sequence of recommendation templates can be based on factors such as, but not limited to, a predetermined threshold count of the matching matrix cells, pattern score magnitude and eminence priority. Eminence priority can be described as weighting factor based on actions having proportional effect on eminence score. For example, a document posting can have more effect on eminence as compared to following another user. The pattern scored recommendation templates matrix can be sent toward MATCHING MATRIX STORE 134 for storage. When operation CREATE TEMPLATE MATRIX 204 completes, processing proceeds toward operation INSTANTIATE ACTION OUTPUT 206.

Operation INSTANTIATE ACTION OUTPUT 206, can determine if a user activates recommendations function (e.g., SOCIAL ACTION ENGINE 128) via interaction with social network software (e.g., SOCIAL NETWORK ENGINE 122). For example, a user can select a “recommendation” tab or a pull-down to open “recommendations” within a social networking interface (e.g., USER APPLICATION(S) 112). When operation INSTANTIATE ACTION OUTPUT 206 is ‘Yes’ (e.g., instantiated), processing proceeds toward operation RECEIVE SOCIAL ANALYTICS 208, otherwise operation INSTANTIATE ACTION OUTPUT 206 processing ends.

Operation RECEIVE SOCIAL ANALYTICS 208, can receive recent social networking activity from one or more social graphs (e.g., SOCIAL GRAPH ANALYTICS 126). Recent social networking activities can comprise activities such as, but not limited to, connections, follows, likes, comments, tags, creates, shares, joins, follows and posts can be identified based on social analytic data. Further, received recent social activity can comprise a user's social eminence scores/rankings for prioritizing recommended social actions. When operation RECEIVE SOCIAL ANALYTICS 208 completes, processing proceeds toward operation DETERMINE RECOMMENDED ACTIONS 210.

Operation DETERMINE RECOMMENDED ACTIONS 210, can receive a user's matching matrix (e.g., MATCHING MATRIX STORE 134), a history of recommended social actions and associated social action status (e.g., RECOMMENDATION STORE 136). RECOMMENDATION GENERATOR 138 can analyze the recent social networking activities (e.g., from SOCIAL GRAPH ANALYTICS 126) to create/update the recommended social actions and assign respective recommended social action rationale. It should be noted that more recent recommended social actions can be sorted as a priority within a recommend action template/category. Further, an indicator can identify recently created recommended social actions (e.g., a social action event indicator). For example, three recommended social actions can be determined for a recommended social action template where one is newly created and two former recommended social actions are received from RECOMMENDATION STORE 136 that have not been acted upon. In this example a “NEW” indicator can be associated toward the first of the three recommended social actions. In addition, the social action event indicator can be active/visible for a timed period. For example, after a predetermined time duration and/or a predetermined viewed output count by a user, a recommended social action can be considered no longer “NEW” and the social action event indicator can be set to an inactive state. When operation DETERMINE RECOMMENDED ACTIONS 210 completes, processing proceeds toward operation OUTPUT RECOMMENDED ACTIONS 212.

Operation OUTPUT RECOMMENDED ACTIONS 212, can store recommended social actions from operation DETERMINE RECOMMENDED ACTIONS 210 toward RECOMMENDATION STORE 136 and/or can output the collection of recommended social actions toward a computer display (e.g., USER APPLICATION(S) 112). The recommended social actions can be output as groups of recommended social actions related to respective recommendation templates. It should be noted that the recommended social actions output sequence comprising the recommendation template can be arranged by factors such as, but not limited to, the user's recent user social networking activity and the relative strength of the social action rationale. It should be noted that stored recommended social actions can create a history of recommended social actions and/or to enable the ability to track social action status for respective recommended social actions and/or to track respective social action event indicators for highlighting recommended social actions. When operation OUTPUT RECOMMENDED ACTIONS 212 completes, processing proceeds toward operation PERFORM ACTION 214.

Operation PERFORM ACTION 214, can monitor user interaction input with displayed recommended social action templates and/or recommended social actions displayed within the recommended social action templates. As a user interacts with display output based on operation OUTPUT RECOMMENDED ACTIONS 212, responses such as, but not limited to, hot-links, pop-ups, hover information and activated buttons can be activated. If operation PERFORM ACTION 214 detects a user interaction input affects the social action status state and/or status indicator value (e.g., a next social action status) of a recommended social action (e.g., ‘Mark as Done’ button activated) then operation PERFORM ACTION 214 (e.g., Yes) responds by proceeding toward operation UPDATE ACTION STATUS 216. Operation PERFORM ACTION 214 can continue processing user interaction input until SOCIAL ACTION ENGINE 128 is complete (e.g., a user exits a “recommendation” screen/display). When user interaction input completes, operation PERFORM ACTION 214 processing ends.

Operation UPDATE ACTION STATUS 216, can store/update the social action status of recommended social actions toward RECOMMENDATION STORE 136 and/or display the social action status toward the user interface. For example, a user can mark recommended social action with status indicators such as, but not limited to, done, hide, ignore, pin (for later). It should be noted that any combination of status indicators can be reversed (e.g., pin/unpin) and a change in social action status (e.g., next social action status) can be updated as the social action status (e.g., current social action status). When operation UPDATE ACTION STATUS 216 completes, processing proceeds toward operation PERFORM ACTION 214.

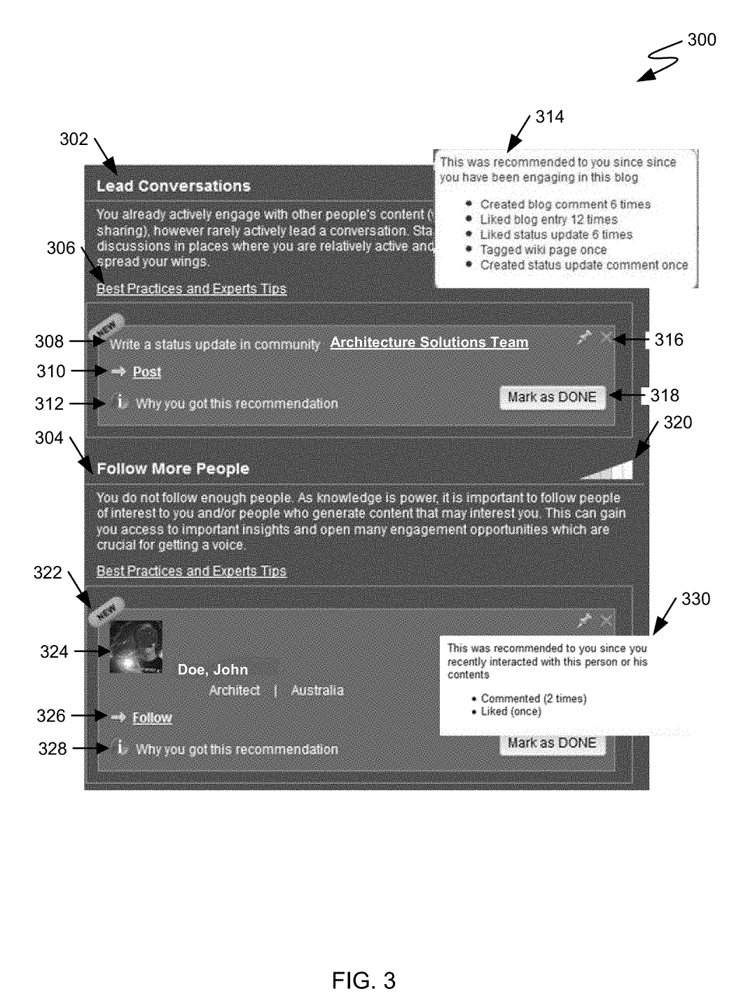

FIG. 3 illustrates sample output of recommended social actions, in accordance with an embodiment of the present invention. The recommended social action output 300 represents a portion of a possible larger collection of recommended social actions and comprises items ACTION TEMPLATE_1 302, ACTION TEMPLATE_2 304, ACTION TIPS 306, RECOMMENDED SOCIAL ACTION TITLE_1 308, RECOMMENDED SOCIAL ACTION_1 310, SOCIAL ACTION RATIONALE INFO_1 312, SOCIAL ACTION RATIONALE DETAIL_1 314, ACTION OPTIONS 316, ACTION CLOSURE 318, ACTION TEMPLATE RELEVANCE 320, SOCIAL ACTION EVENT INDICATOR 322, RECOMMENDED SOCIAL ACTION TITLE_2 324, RECOMMENDED SOCIAL ACTION_2 326, SOCIAL ACTION RATIONALE INFO_2 328 and SOCIAL ACTION RATIONALE DETAIL_2 330.

Items ACTION TEMPLATE_1 302 and ACTION TEMPLATE_2 304 illustrate respective first and second recommendation templates received from RECOMMENDATION STORE 136. Output of items ACTION TEMPLATE_1 302 and ACTION TEMPLATE_2 304 illustrate a sample of available action templates comprising ACTION TEMPLATE STORE 130 recommendation template, identified in a matching matrix for a user (e.g., Mary Smith).

Item RECOMMENDED SOCIAL ACTION TITLE_1 308 illustrates title of a first recommended social action. In this example, a community is identified in relation to the recommended social action.

Item RECOMMENDED SOCIAL ACTION_1 310 illustrates a first recommended social action. In this example, a posting is recommended toward the 308 community. It should be noted that the action can be a hot-link to launch a posting to the 308 community.

Item SOCIAL ACTION RATIONALE INFO_1 312 illustrates hot-link to further explain the rationale for the specific recommended social action 310

Item SOCIAL ACTION RATIONALE DETAIL_1 314 illustrates a pop-up window based on selecting item SOCIAL ACTION RATIONALE INFO_1 312 and describe why the recommended social action was suggested. In this example, the user has interacted with “Architecture Solutions Team” (e.g., item RECOMMENDED SOCIAL ACTION TITLE_1 308) and item SOCIAL ACTION RATIONALE DETAIL_1 314 displays social action rationale associated with the recommended social action to suggest the user should contribute to the knowledge base of the community.

Item ACTION OPTIONS 316 illustrates action options can enable a user to ignore or save a recommended social action for later action.

Item ACTION CLOSURE 318 illustrates an action button that enable a user to acknowledge the recommended social action as completed.

Item ACTION TEMPLATE RELEVANCE 320 illustrates an indicator can be based on color and/or magnitude to indicate a strength/weakness of social eminence for the related action template.

Item SOCIAL ACTION EVENT INDICATOR 322 illustrates an event indicator that can highlight a new recommended social action has been determine/presented. It should be noted that after a predetermined period (e.g., one day) 322 can be removed or replaced by another indicator to represent aging of the recommended social action.

Item RECOMMENDED SOCIAL ACTION TITLE_2 324 illustrates identifier of a second recommended social action. In this example a person's photo and name are displayed related to the recommended social action. It should be noted that that a plurality of recommended social actions can be presented within a recommendation template. For example, more than one person can be recommended for following where each recommendation can be supported for a respective social action rationale.

Item RECOMMENDED SOCIAL ACTION_2 326 illustrates a second recommended social action. In this example a follow action is recommended toward the 324. It should be noted that the action can be a hot-link to launch a follow action with person in 324.

Item SOCIAL ACTION RATIONALE INFO_2 328 illustrates hot-link to further explain the rationale for the specific recommended social action 326

Item SOCIAL ACTION RATIONALE DETAIL_2 330 illustrates a pop-up window based on selecting item SOCIAL ACTION RATIONALE INFO_2 328 to display social action rationale for the recommended social action item RECOMMENDED SOCIAL ACTION_2 326. In this example, the user has interacted with John Doe (e.g., item RECOMMENDED SOCIAL ACTION TITLE_2 324) and the recommended social action suggests following John Doe as the user may share common interests with Mary Smith on which to collaborate.

Thus, as presented in an illustrated sample output of recommended social actions, in accordance with an embodiment of the present invention, recommended social actions can be shown to be: “actionable” (e.g., encompassing a specific action for a user to take to improve social eminence) and “justifiable” (e.g., recommended social actions comprising explanation of the reasons/rationale for a recommended social action). It should be noted that recommended social action and/or social action rationale can be based on a user's social networking activity corpus to achieve “contextual” and/or “temporal” relevance. For example, the recommended social actions can be based on factors such as, but not limited to, user activities, other user activities in the user's network and other activities affecting social content items associate with the user and as social activity transpires, recommended social actions and/or social action rationale can reflect the social activity. For example, a recommended social action to create a “blog entry” can comprise social action rationale “you commented 8 times and liked 10 times, entries in this community thus you are familiar with it and have knowledge to share” and as the blog activity progresses, the social action rationale content can reflect current relevant information.

FIG. 4 illustrates a block diagram of components of COMMUNICATION DEVICE 110 and COMPUTER SYSTEM 120 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computer system 400 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Computer system 400 includes processors 404, cache 416, memory 406, persistent storage 408, communications unit 410, input/output (I/O) interface(s) 412 and communications fabric 402. Communications fabric 402 provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of processors 404 by holding recently accessed data, and data near recently accessed data, from memory 406.

Program instructions and data used to practice some embodiments may be stored in persistent storage 408 and in memory 406 for execution by one or more of the respective processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Program instructions and data used to practice some embodiments may be downloaded to persistent storage 408 through communications unit 410.

I/O interface(s) 412 allows for input and output of data with other devices that may be connected to each computer system. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice some embodiments can be stored on such portable computer readable storage media and can be loaded onto persistent storage 408 via I/O interface(s) 412. I/O interface(s) 412 also connect to display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

The term “present invention” should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

The term “and/or” should be understood as inclusive or; for example, A, B “and/or” C means that at least one of A, B or C is true and applicable. Further, “at least one of A, B, or C” should be interpreted to mean only A, only B, only C, or any combination of A, B, and C.

What is claimed is:

1. A method for creating personalized recommended social media actions to improve social eminence within a social network, the method comprising:
receiving, by one or more computer processors, persona social traits and one or more social graphs associated with a user;
receiving, by one or more computer processors, predetermined one or more recommendation templates for grouping one or more recommended social actions;
creating, by one or more computer processors, a matching matrix based on matching action categories of the one or more recommendation templates with the persona social traits for the user;
scoring, by one or more computer processors, matching matrix cells of the matching matrix with a pattern score based on the persona social traits;
analyzing, by one or more computer processors, the one or more social graphs to create one or more recommended social actions;
outputting, by one or more computer processors, the one or more recommended social actions, wherein the one or more recommended social actions are grouped by the one or more recommendation templates respectively, and wherein the one or more recommended social actions comprise a collection of social actions and social action rationale, and wherein the one or more recommended social actions is based on traversing the one or more social graphs to identify social actions and social network activity evidence to support social action rationale, and wherein the one or more recommended social actions output sequence comprising the recommendation template is based on at least one of the user's recent user social networking activity and relative strength of social action rationale, and wherein the one or more recommendation templates output sequence is based on a predetermined sequence, the pattern score magnitude and eminence priority;
outputting, by one or more computer processors, one or more social action status associated with the one or more recommended social actions;
storing, by one or more computer processors, the one or more social action status and the one or more recommended social actions;
receiving, by one or more computer processors, user interaction input, wherein the user interaction input marks the one or more recommended social action with status indicators of at least one of done, hide, ignore or pin for later, creating a next one or more social action status; and
responsive to receiving the next one or more social action status, updating, by one or more computer processors, the one or more social action status associated with the next one or more social action status.
